(19) United States
(12) Patent Application Publication
(10) Pub. No.: US 2024/0188703 A1
(43) Pub. Date: Jun. 13, 2024

(54) RAZOR CLEANING APPARATUS

(71) Applicant: Jeff Shane Hut, Mission (CA)

(72) Inventor: Jeff Shane Hut, Mission (CA)

(21) Appl. No.: 18/064,486

(22) Filed: Dec. 12, 2022

(51) Int. Cl. A45D 27/46; B08B 3/02; B08B 3/14; B08B 11/02

(52) U.S. Cl. CPC A45D 27/46; B08B 3/02; B08B 3/14; B08B 11/02; B08B 2203/027

(57) ABSTRACT

A razor cleaning apparatus that is configured to provide cleaning of a razor blade through removal of hair and debris from between the gaps of blades on a razor. The present invention includes a reservoir wherein the reservoir is configured to receive and retain a cleaning fluid. An outer housing is surroundably mounted to the reservoir and is slidably secured thereover. A razor cradle is positioned proximate the top of the outer housing and includes a second portion extending outward configured to support a razor handle. A razor cleaning section is superposed the upper end of the outer housing having an interior volume configured to receive a razor blade therein. A pump member is fluidly coupled to a delivery tube wherein the delivery tube transfers cleaning fluid from the reservoir into the razor cleaning section ejecting water from nozzles mounted on the upper section of the delivery tube.

### FIELD OF THE INVENTION

The present invention relates generally to personal hygiene apparatus, more specifically but not by way of limitation, a razor cleaning apparatus that is configured to receive a shaving razor therein and provide removal of the hair lodged intermediate the blades of the shaving razor.

### BACKGROUND

The personal hygiene market has been expanding over the last decade. A multitude of new products have been introduced into the market place that assist individuals perform improved personal hygiene. Additionally, in conjunction with new product introductions there have been improvements made for existing products. One product used by both men and women is the razor. The conventional razor has been commercially available for decades. Razors are used by both men and women for personal grooming. Over the last decade, a plurality of improvements have been made to the razor. These improvements include but are not limited to lubricant strips added to the razor head, blade quantity changes and blade movement capabilities are just a few of the improvements made to the conventional razor.

While the conventional razor has had improvements made thereto, a long-lasting problem therewith still exists. The conventional razor blade has the blades thereof spaced such that there is typically not more than one millimeter of space between each blade. The blade spacing impacts the closeness of shave and as such the range of gap between razor blades amongst commercially available razors is fairly narrow. The spacing between blades commonly results in hair getting clogged therein. As hair pieces get clogged in between the razor blades the performance of the razor diminishes significantly. Commonly, individuals will attempt to remove the hair between the blades by placing the blade under running water or washing the blade in a sink. These existing techniques have proven ineffective for removal of hair between the blades of a razor.

Accordingly, it is intended within the scope of the present invention to provide a razor cleaning apparatus that is configured to provide removal of hair between the blades of a razor through utilization of a water stream directed through a plurality of nozzles at a razor blade disposed within the present invention.

### SUMMARY OF THE INVENTION

It is the object of the present invention to provide a device configured to provide cleaning of hair lodged between blades of a razor wherein the present invention includes a reservoir operable to retain a cleaning fluid therein.

Another object of the present invention is to provide an apparatus operable to provide cleaning of a razor blade wherein the apparatus includes a housing that is surroundably mounted and superposed to the reservoir.

A further object of the present invention is to provide a device configured to provide cleaning of hair lodged between blades of a razor wherein the present invention includes an upper housing configured to receive a portion of a razor therein.

Still another object of the present invention is to provide an apparatus operable to provide cleaning of a razor blade wherein the upper housing includes an aperture formed in the side wall thereof wherein the aperture further includes a bristle assembly at the opening.

An additional object of the present invention is to provide a device configured to provide cleaning of hair lodged between blades of a razor wherein the present invention includes a razor cradle that is configured to have a razor superposed thereon.

Yet a further object of the present invention is to provide an apparatus operable to provide cleaning of a razor blade that further includes a pump member wherein the pump member includes a delivery tube and an engagement button.

Another object of the present invention is to provide a device configured to provide cleaning of hair lodged between blades of a razor wherein the upper housing further includes a plurality of water nozzles that are configured to eject water therefrom.

Still a further object of the present invention is to provide an apparatus operable to provide cleaning of a razor blade wherein the housing includes a view window formed therein operable to provide visual indication of the amount of fluid disposed in the reservoir.

Yet another object of the present invention is to provide a device configured to provide cleaning of hair lodged between blades of a razor that further includes a retention assembly configured to releasably secure the present invention in a desired position.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the outer housing of the present invention; and

FIG. 2 is a perspective view of the present invention disposed in an embodiment of the holding member; and

FIG. 3 is a perspective view of the razor cradle of the present invention; and

FIG. 4 is a side view of the present invention; and

FIG. 5 is an exploded side diagrammatic view of the present invention.

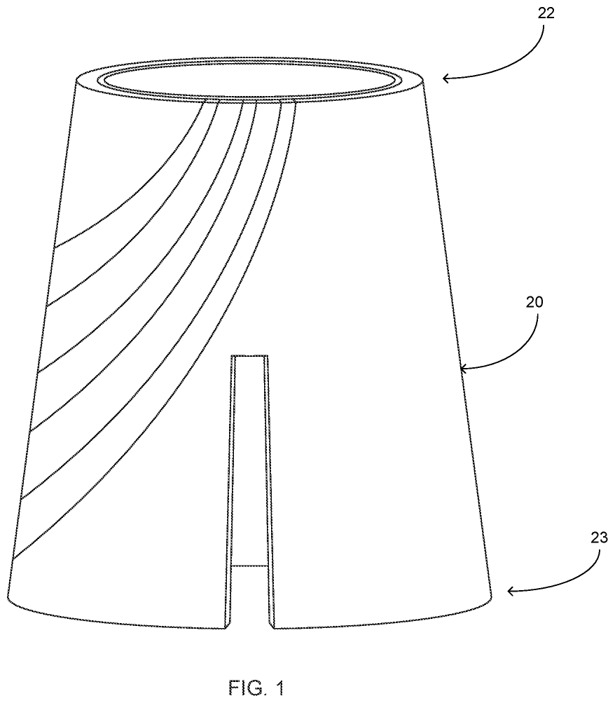

### DETAILED DESCRIPTION

Referring now to the drawings submitted herewith, wherein various elements depicted therein are not necessarily drawn to scale and wherein through the views and figures like elements are referenced with identical reference numerals, there is illustrated a razor cleaning apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to Figures herein, the razor cleaning apparatus 100 includes a reservoir 10 that is configured to receive and retain a cleaning fluid such as but not limited to water. The reservoir 10 is manufactured from a durable rigid material such as but not limited to transparent plastic. The reservoir 10 includes bottom 11 and sidewall 12 integrally formed to create an interior volume 13. The reservoir is generally cylindrical in shape being tapered toward the upper end 14 thereof. Proximate the upper end 14 is opening 15 wherein the opening 15 provides access to the interior volume 13. It should be understood within the scope of the present invention that the reservoir 10 could be provided in alternate shapes and sizes suitable to receive and retain cleaning fluid therein. Secured within the interior volume 13 of the reservoir 10 proximate the bottom 11 thereof is grid member 16. The grid member 16 is suspended above the bottom 11 and is structured with a plurality of apertures 17 to allow water and debris to flow therethrough. The grid member 16 allows water and debris from a razor head to flow therethrough in order to collect at the bottom 11. As is further discussed herein, the end 41 of the delivery tube 40 is above the grid member 16 when the razor cleaning apparatus 100 is assembled to facilitate avoidance of the delivery tube 40 having debris introduced thereinto and transported to the razor cleaning section 50.

Surroundably mounted to the reservoir 10 is the outer housing 20. The outer housing 20 includes wall 21 and has an upper end 22 and lower end 23. The outer housing 20 is manufactured from a durable rigid material such as but not limited to plastic and is tapered in shape so as to mateably slide over the reservoir 10. It should be understood within the scope of the present invention that the outer housing 20 is provided in a shape that is slidably mateable to the reservoir 10 in order to facilitate the surroundable mounting thereto. A view window 25 is formed in the wall 21 of the outer housing 20. The view window 25 is vertically oriented and is configured to allow a user of the razor cleaning apparatus 100 to identify the amount of fluid disposed within the reservoir 10. It should be understood within the scope of the present invention that the view window 25 could be formed having alternate widths and heights and achieve the desired objective discussed herein.

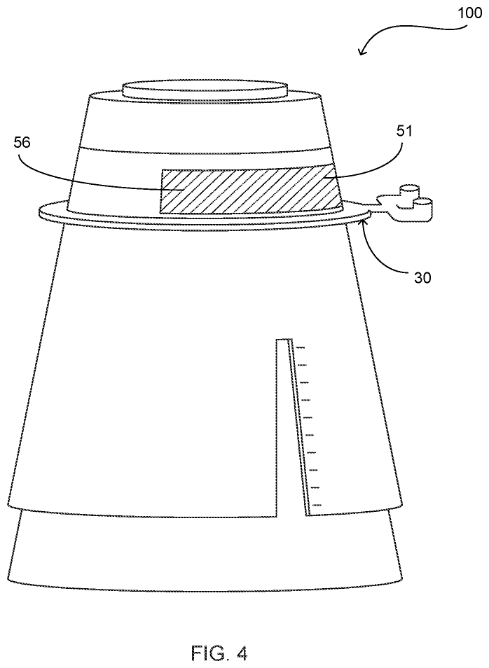

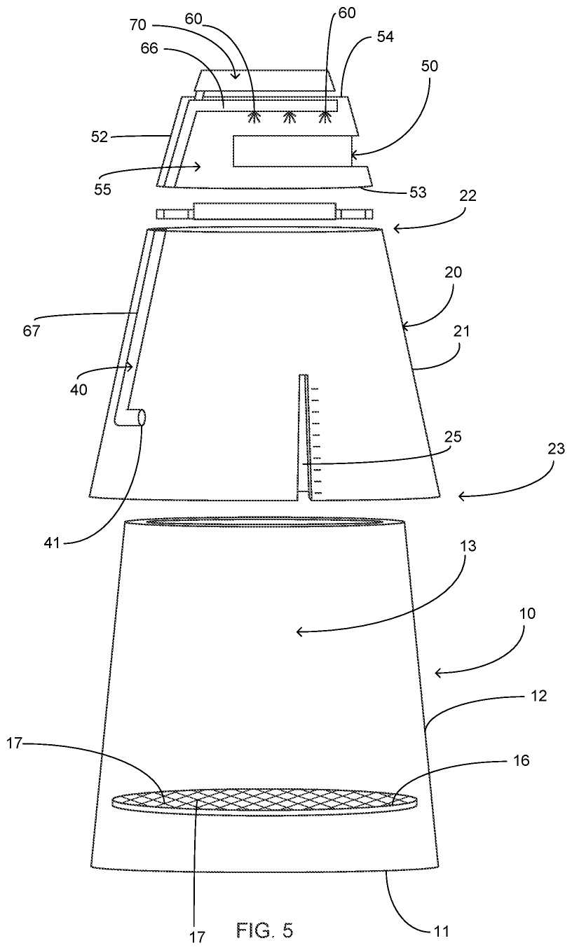

Located at the upper end 22 of the outer housing 20 is the razor cradle 30. The razor cradle 30 functions to receive and retain a shaving razor so as to hold in position for cleaning of the razor blade thereof. The razor cradle 30 includes a first portion 31 contiguously formed with a second portion 32. The first portion 31 is ring shaped so as to be surroundably mounted to the outer housing 20 as illustrated herein in FIG. 4. The razor cradle 30 is positioned immediately below the opening 51 to the razor cleaning section 50. The second portion 32 of the razor cradle 30 includes lateral support members 34,36 having a void 35 therebetween. The second portion 32 of the razor cradle 30 is configured to have a handle portion of a shaving razor superposed thereon and provide support thereof during use of the razor cleaning apparatus 100. Lateral support members 34, 36 include ends 37,38 that extend upward therefrom and are perpendicular thereto. While a particular embodiment of the razor cradle 30 has been illustrated and discussed herein, it is contemplated within the scope of the present invention that the razor cradle 30 could be formed and provided in numerous alternate embodiments and achieve the objective discussed herein.

The razor cleaning section 50 is superposed the upper end 22 of the outer housing 20. The razor cleaning section 50 includes wall 52, bottom 53 and top 54 integrally formed to create interior volume 55. Opening 51 provides access to the interior volume 55 and facilitates placement of a razor blade therein. Opening 51 has providing coverage thereof bristle members 56 wherein the bristle members 56 inhibit spray of cleaning fluid from egressing outward of the opening 51. It is contemplated within the scope of the present invention that the opening 51 could be provided with alternate elements to inhibit spray of cleaning fluid from egressing outward of the opening 51. Furthermore, it is additionally contemplated within the scope of the present invention that the razor cleaning section 50 could be provided without bristle members 56.

Mounted within the razor cleaning section 50 are a plurality of nozzles 60. Nozzles 60 are operably coupled to the upper section 66 of the delivery tube 40. The upper section 66 of the delivery tube 40 is contiguously formed with the middle section 67 being generally perpendicular thereto and fluidly coupled therewith. Cleaning fluid travels upward through the middle section 67 subsequent introduction from tube end 41 into the upper section 66 and egresses from the nozzles 60. Cleaning fluid egressing from the nozzles 60 has sufficient pressure to dislodge hair and debris present in the gaps between a razor blade. It is contemplated within the scope of the present invention that the razor cleaning apparatus 100 could include alternate quantities and arrangements of nozzles 60 in order to provide effective cleaning of a razor blade.

The delivery tube 40 is operably coupled to pump member 70. Pump member 70 provides control of the water flow through the delivery tube 40 as discussed herein. In one embodiment of the pump member 70, the pump member 70 is manually operated through repeated downward presses thereof leveraging a vacuum effect so as to facilitate movement of cleaning fluid through the delivery tube 40 as discussed herein. It is contemplated within the scope of the present invention that numerous alternate elements could be employed to form the pump member 70. By way of example but not limitation, the pump member 70 could include a battery operated pump motor that would facilitate flow of cleaning fluid as discussed herein.

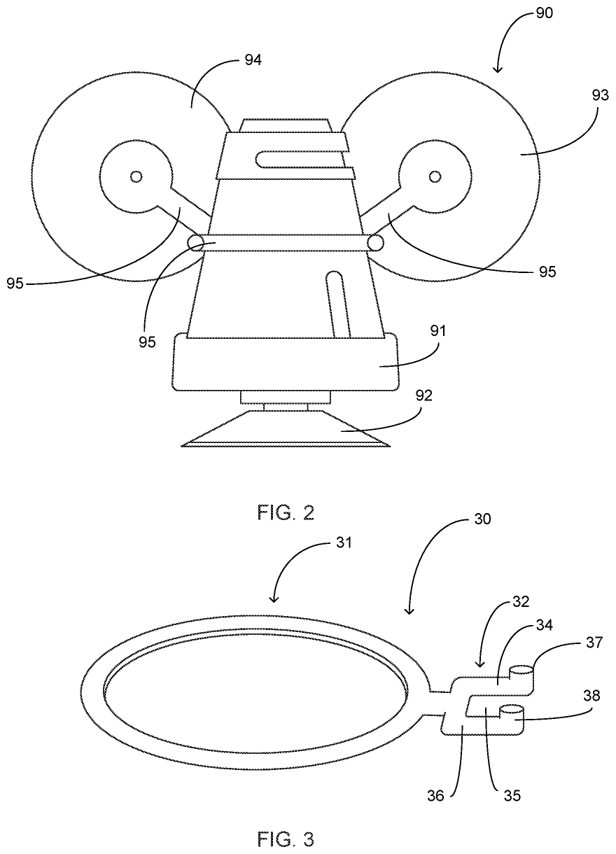

The razor cleaning apparatus 100 includes a holding member 90 illustrated herein in FIG. 2. The holding member 90 is operable to assist in maintaining the position of the razor cleaning apparatus 100 on a countertop or other area in which a user may place the razor cleaning apparatus 100. The holding member 90 includes lower support tray 91 having suction cup 92 secured to the bottom thereof. Lateral support suction cups 93,94 are operably coupled to the outer housing 20 utilizing a configuration of support arm members 95. It is contemplated within the scope of the present invention that the holding member 90 could be provided in numerous alternate configurations in order to achieve the desired objective discussed herein of providing stability of position of the razor cleaning apparatus 100 during use thereof.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A razor blade cleaning apparatus configured to provide cleaning of a razor blade of a shaving razor wherein the razor blade cleaning apparatus comprises:
a reservoir, said reservoir having at least one wall and a bottom forming an interior volume, said reservoir having an upper end and a lower end, said reservoir configured to receive and retain a cleaning fluid therein,
an outer housing, said outer housing configured to surroundably mount said reservoir, said outer housing having a wall, said outer housing being mateably shaped with said reservoir being operable to slidably engage therewith;
a razor cleaning section, said razor cleaning section being superposed said outer housing, said razor cleaning section having a bottom, a top and at least one wall forming an interior volume, said razor cleaning section having an opening formed in said at least one wall thereof, said opening configured to have a portion of a shaving razor journaled therethrough; and
a pump member, said pump member being fluidly coupled to a delivery tube, said delivery tube configured to transfer the cleaning fluid from said reservoir to the razor cleaning section, wherein the cleaning fluid is dispersed from an upper section of the delivery tube onto a razor blade proximate thereto.

2. The razor blade cleaning apparatus configured to provide cleaning of the razor blade of the shaving razor as recited in claim 1, wherein said delivery tube includes a middle section, said middle section being fluidly coupled with said upper section, said middle section having an end, said end disposed within the interior volume of said reservoir.

3. The razor blade cleaning apparatus configured to provide cleaning of the razor blade of the shaving razor as recited in claim 2, wherein said upper section of said delivery tube includes a plurality of nozzles, said plurality of nozzles operable to disperse cleaning fluid into the interior volume of the razor cleaning section.

4. The razor blade cleaning apparatus configured to provide cleaning of the razor blade of the shaving razor as recited in claim 3, wherein said outer housing further includes a view window, said view window being vertically oriented on the at least one wall of said outer housing.

5. The razor blade cleaning apparatus configured to provide cleaning of the razor blade of the shaving razor as recited in claim 4, and further including a razor cradle, said razor cradle being proximate said razor cleaning section, said razor cradle configured to receive and retain a shaving razor during cleaning of the razor blade thereof.

6. The razor blade cleaning apparatus configured to provide cleaning of the razor blade of the shaving razor as recited in claim 5, and further including a grid member, said grid member being disposed within the interior volume of said reservoir, said grid member being proximate said lower end of said reservoir, said grid member having a plurality of apertures allowed dispensed cleaning fluid to flow therethrough.

7. The razor blade cleaning apparatus configured to provide cleaning of the razor blade of the shaving razor as recited in claim 6, wherein said razor cradle includes a first portion and a second portion, said second portion of said razor cradle extending outward from said outer housing.

8. The razor blade cleaning apparatus configured to provide cleaning of the razor blade of the shaving razor as recited in claim 7, wherein said opening formed in the at least one wall of said razor cleaning section further includes bristle members configured to provide coverage thereof.

9. The razor blade cleaning apparatus configured to provide cleaning of the razor blade of the shaving razor as recited in claim 8, wherein said first portion of said razor cradle in an annular ring configured to be mounted to said at least one wall of said outer housing.

10. The razor blade cleaning apparatus configured to provide cleaning of the razor blade of the shaving razor as recited in claim 9, wherein said reservoir is manufactured from a transparent plastic.

11. A razor blade cleaning apparatus configured to provide cleaning of a razor blade of a shaving razor wherein the razor blade cleaning apparatus comprises:
a reservoir, said reservoir having at least one wall and a bottom forming an interior volume, said reservoir having an upper end and a lower end, said reservoir configured to receive and retain a cleaning fluid therein,
an outer housing, said outer housing configured to surroundably mount said reservoir, said outer housing having a wall, said outer housing being mateably shaped with said reservoir being operable to slidably engage therewith;
a razor cleaning section, said razor cleaning section being superposed said outer housing, said razor cleaning section having a bottom, a top and at least one wall forming an interior volume, said razor cleaning section having an opening formed in said at least one wall thereof, said opening configured to have a portion of a shaving razor journaled therethrough;
a razor cradle, said razor cradle being mounted to said outer housing, said razor cradle having a first portion and a second portion, said first portion of said razor cradle being ring shaped and surroundably mounted to said outer housing, said second portion of said razor cradle being contiguous with said first portion, said second portion extending outward from said outer housing;
a pump member, said pump member being fluidly coupled to a delivery tube, said delivery tube configured to transfer the cleaning fluid from said reservoir to the razor cleaning section, wherein the cleaning fluid is dispersed from an upper section of the delivery tube onto a razor blade proximate thereto, said upper section of said delivery tube having a plurality of nozzles configured to disperse cleaning fluid into the interior volume of said razor cleaning section.

12. The razor blade cleaning apparatus configured to provide cleaning of the razor blade of the shaving razor as recited in claim 11, wherein the second portion of the razor cradle includes lateral support members, said lateral support members being parallel and having a void therebetween, said lateral support members configured to support a portion of a handle of the shaving razor.

13. The razor blade cleaning apparatus configured to provide cleaning of the razor blade of the shaving razor as recited in claim 12, and further including a holding member, said holding member being operably coupled to said outer housing, said holding member having at least one support arm and at least one suction cup.

14. The razor blade cleaning apparatus configured to provide cleaning of the razor blade of the shaving razor as recited in claim 13, wherein said outer housing further includes a view window, said view window being vertically oriented on the at least one wall of said outer housing.

15. The razor blade cleaning apparatus configured to provide cleaning of the razor blade of the shaving razor as recited in claim 14, and further including a grid member, said grid member being disposed within the interior volume of said reservoir, said grid member being proximate said lower end of said reservoir, said grid member having a plurality of apertures allowed dispensed cleaning fluid to flow therethrough.
